(19) United States
(12) Patent Application Publication
(10) Pub. No.: US 2020/0371473 A1
(43) Pub. Date: Nov. 26, 2020

(54) METHOD FOR MANUFACTURING LIGHT REFLECTION MEMBER FOR PRODUCING HOLOGRAM EFFECT OF ORNAMENT AND HOLOGRAM PRODUCTION DEVICE

(71) Applicant: ITECH INC., Gwangju (KR)

(72) Inventors: Chang-Ju LEE, Gwangju (KR); Dong-Sub HONG, Gwangju (KR)

(21) Appl. No.: 16/881,658

(22) Filed: May 22, 2020

(30) Foreign Application Priority Data
May 24, 2019 (KR) 10-2019-0061164

(51) Int. Cl. G03H 1/02; G03H 1/04; G02B 5/02

(52) U.S. Cl. CPC G03H 1/02; G03H 1/041; G02B 5/0252; G03H 2001/0228; G03H 2223/14; G03H 2001/0216; G02B 5/0268

(57) ABSTRACT

A method for manufacturing a light reflection member producing a hologram effect of an ornament, the method including the steps of: applying an adhesive to a substrate; attaching a background member to the adhesive; applying an adhesive to the background member; applying silibeads to the adhesive; heating the silibeads to a temperature of 160±5° C.; applying an adhesive to the silibeads; applying polystyrene beads to the adhesive; and heating the polystyrene beads to a temperature of 100±5° C. According to the present invention, the method for manufacturing the light reflection member for producing the hologram effect of the ornament can produce the hologram effect from the solid light behind the ornament through the illuminance of the lighting member and the reflected light from the light reflection member, thereby providing the dynamic hologram effect for the ornament.

### BACKGROUND

The present invention relates to a method for manufacturing a light reflection member for producing a hologram effect of an ornament such as a candle, and the like and also, to a light technology that is capable of producing a dynamic hologram effect behind an ornament through the use of scattered reflection of light from a light reflection member attached to a background member.

Generally, solid lighting provides various solid images through different observation positions from an incident angle of the light emitted from a light source.

The solid lighting is excellent in visual image enhancement of an artifact, brand promotion, and a sales promotion effect of a product. Conventional technologies for producing impressive images of solid lighting have been developed and suggested. Such conventional technologies are as follows.

One of the conventional technologies is disclosed in Korean Patent Application Laid-open No.10-2018-0080894 entitled “lighting device for ornament”. The conventional lighting device for an ornament is capable of providing a visual effect as well as a lighting effect for the ornament even in a dark environment, and the conventional lighting device includes the ornament, a light emitting member located behind the ornament to emit light, and light reflection members for reflecting the light emitted from the light emitting member to produce hologram lighting around the ornament, wherein the light reflection members are spaced apart from each other by a given distance behind the ornament in such a manner as to have a plurality of reflection particles to be applied to the surfaces thereof to a shape corresponding to the outer shape of the ornament or a given portion of the ornament, so that when the light emitted from the light emitting member is reflected onto the reflection particles of the light reflection members, a given lighting effect can be provided for the ornament by means of the scattered reflection of the reflection particles.

Another conventional technology is disclosed in Korean Patent Application Laid-open No.10-2017-0129635 (Dated on Nov. 27, 2017) entitled “device and method for producing solid lighting in air”. The conventional technology is disclosed in FIG. 1. According to the conventional technology, the device for producing solid lighting in air has a reflector whose angle is adjustable up and down or left and right to allow a moving direction of light to be changed and a lighting member whose position is movable to allow an inclination of light to be changed.

In the conventional technology, if 0.15 to 0.36 mm of plastic media is coated, within one circle of light formed by a glass bead fabric, another circle produced by the plastic media can be produced. After glass beads having different sizes or kinds from the glass bead fabric are mixed with the plastic media, next, if the mixture is applied to a surface of the glass bead fabric, a substantially large number of three-dimensional circles are formed on the surface of the glass bead fabric, thereby producing background lighting more solidly. A mixing ratio of the glass beads to the plastic media is 7:3 to 5:5, which is determined in consideration of the injected capability of the light reflection members through an air gun and the adhesion capability of a background member to an adhesive.

In the conventional practice, however, the light reflection members are scattered strongly by means of the air gun, so that a large number of light reflection members may be lost. To prevent the light reflection members from being scattered in every direction, accordingly, other devices have to be used.

In the conventional practice, also, it is possible to dry the light reflection members to a given temperature, but if the glass beads are mixed with other light reflection materials and laminated thereon most rapidly, it is not easy for a person skilled in the art to find the given temperature. Only when a great number of tests are repeatedly carried out, accordingly, the most appropriate temperature can be found.

The above-mentioned conventional technologies can produce a halo effect or hologram effect of the ornament, but they do not disclose or suggest any method for manufacturing a light reflection member for producing two circular holograms and any dynamic effect of the two circular holograms.

### PRIOR ART DOCUMENT

(Patent document 1) Korean Patent Application Laid-open No.10-2018-0080894 (Dated on Jul. 13, 2018)

(Patent document 2) Korean Patent Application Laid-open No.10-2017-0129635 (Dated on Nov. 27, 2017)

(Patent document 3) Korean Patent No.10-1115748 (Issued on Mar. 6, 2012)

(Patent document 4) Korean Patent No.10-0981056 (Issued on Sep. 2, 2010)

### SUMMARY OF THE INVENTION

Accordingly, the present invention has been made in view of the above-mentioned problems occurring in the related art, and it is an object of the present invention to provide a method for manufacturing a light reflection member for producing a hologram effect of an ornament that is capable of producing two holograms having different sizes from solid light behind the ornament through the reflected light from a light reflection member, while providing dynamic effects of the two holograms.

### Technical Solution

To accomplish the above-mentioned object, according to one aspect of the present invention, there is provided a method for manufacturing a light reflection member for producing a hologram effect of an ornament, the method including the steps of: applying an adhesive to a substrate; attaching a background member to the adhesive; applying an adhesive to the background member; applying silibeads to the adhesive; heating the silibeads to a temperature of 160±5° C.; applying an adhesive to the silibeads; applying polystyrene beads to the adhesive; and heating the polystyrene beads to a temperature of 100±5° C.

According to the present invention, desirably, at the step of applying silibeads to the adhesive and at the step of applying polystyrene beads to the adhesive, the silibeads and the polystyrene beads have particle sizes ranging from 0.2 to 0.3 mm.

According to the present invention, desirably, at the step of applying polystyrene beads to the adhesive, the silibeads and the polystyrene beads have particle sizes smaller than 0.2 mm or larger than 0.3 mm.

To accomplish the above-mentioned object, according to another aspect of the present invention, there is provided a hologram production device comprising a lighting member located between the light reflection member manufactured by the method according to one aspect of the present invention and the ornament, the lighting member being controlled in illuminance to generate rainbow light through the mixture of the silibeads and the polystyrene beads.

According to the present invention, desirably, power is applied alternately at different voltages to the lighting member at intervals of 1/16 seconds or more so that given illuminance values of first and second lighting are different from each other.

According to the present invention, desirably, the power is applied slowly from a low voltage to a high voltage to the lighting member until the first and second lighting reaches the given illuminance values, so that holograms appear slowly.

According to the present invention, desirably, the power of the lighting member is controlled in such a manner as to slowly become a low voltage from a voltage corresponding to the given illuminance values of the first and second lighting, so that holograms disappear slowly.

### Advantageous Effects

According to the present invention, the method for manufacturing the light reflection member for producing the hologram effect of the ornament can produce the hologram effect from the solid light behind the ornament through the illuminance of the lighting member and the reflected light from the light reflection member, thereby providing the dynamic hologram effect for the ornament.

In addition, the method according to the present invention can produce the two holograms and also provide the dynamic effects of the two holograms. Further, the method according to the present invention can manufacture a device for producing two holograms in a stable manner.

### BRIEF DESCRIPTION OF DRAWINGS

FIG. 1 is a flowchart showing a method for manufacturing a light reflection member of a hologram production device in a conventional practice.

FIG. 2 is a flowchart showing a method for manufacturing a light reflection member for producing a hologram effect of an ornament according to the present invention.

FIG. 3 is a side view showing an operation of a hologram production device according to the present invention.

FIG. 4 is a perspective view showing a first operation of the hologram production device according to the present invention.

FIG. 5 is a perspective view showing a second operation of the hologram production device according to the present invention.

### MODE FOR INVENTION

Hereinafter, an explanation on the present invention will be in detail given with reference to the attached drawings.

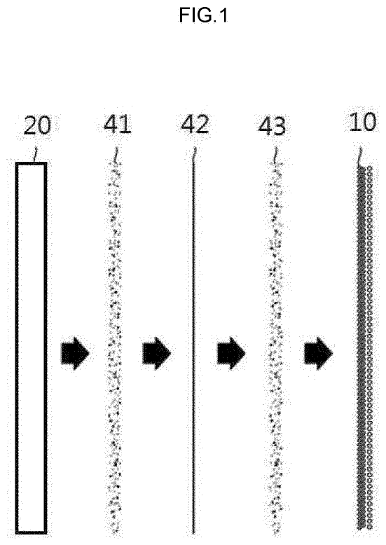

FIG. 1 is a flowchart showing a method for manufacturing a light reflection member of a hologram production device in a conventional practice. According to the conventional practice, glass beads having different sizes or kinds from a glass bead fabric are mixed with plastic media, and next, the mixture is applied to a surface of the glass bead fabric to allow a substantially large number of three-dimensional circles to be formed on the surface of the glass bead fabric, thereby producing background lighting more solidly. Within a circle of light formed by the glass bead fabric, in detail, another circle produced by the plastic media can be produced. A mixing ratio of the glass beads to the plastic media is 7:3 to 5:5 in consideration of the injected capability of the light reflection member 10 through an air gun and the adhesion capability of a background member to an adhesive.

In the conventional practice, however, the glass beads and the plastic media, as the light reflection member 10, are mixed with each other and then scattered strongly by means of the air gun, so that a large number of glass beads and plastic media as the light reflection member 10 may be lost. To prevent them from being scattered in every direction, accordingly, other devices have to be used.

In the conventional practice, also, it is possible to dry the light reflection member 10 to a given temperature, but if the glass beads are mixed with other light reflection members and laminated thereon most rapidly, it is not easy for a person skilled in the art to find the given temperature. Only when a great number of tests are repeatedly carried out, accordingly, the most appropriate temperature can be found.

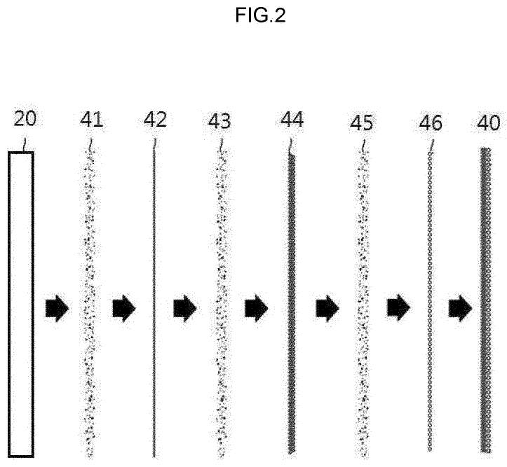

FIG. 2 is a flowchart showing a method for manufacturing a light reflection member for producing a hologram effect of an ornament according to the present invention, and through the method, the light reflection member 40 is manufactured. According to the present invention, the light reflection member 40 includes a first lighting reflection member and a second lighting reflection member. The first lighting reflection member includes silibeads 44, and the second lighting reflection member includes polystyrene beads 46. The silibeads 44 as the first lighting reflection member have chemical components (unit: %) as listed in Table 1, and the polystyrene beads 46 as the second lighting reflection member make use of a commercial product.

TABLE 1

| Material Type | SiO₂ | Na₂O | K₂O | CaO | MgO | Al₂O₃ | B₂O₃ | Fe₂O₃ | ZnO | PbO |
|---|---|---|---|---|---|---|---|---|---|---|
| S | 72 | 13.8 | 0.1 | 9 | 4 | 1 | — | 0.1 | — | <0.01 |
| SL | 57 | 0.2 | 0.6 | 18 | 3 | 14 | 7 | <0.3 | — | <0.01 |
| M | 66 | 16 | 0.01 | 7 | 2 | 5 | 3 | 1 | 1 | <0.01 |
| P | 70.5 | 9 | 8 | 4 | 1.5 | 1.5 | 1.5 | — | 3 | <0.01 |

The method for manufacturing the light reflection member 40 for producing a hologram effect of an ornament according to the present invention includes the steps of: (a) applying an adhesive 41 to a substrate 20; (b) attaching a background member 42 to the adhesive 41; (c) applying an adhesive 43 to the background member 42; (d) applying silibeads 44 to the adhesive 43; (e) heating the silibeads 44 to a temperature of 160±5° C.; (f) applying an adhesive 45 to the silibeads 44; (g) applying polystyrene beads 46 to the adhesive 45; and (h) heating the polystyrene beads 46 to a temperature of 100±5° C.

The light reflection member 40 manufactured through the above-mentioned steps has an improvement in adhesion and manufacturing time.

Instead of the adhesive 43, of course, transparent ink may be used.

At the steps of (e) heating the silibeads 44 to a temperature of 160±5° C. and (h) heating the polystyrene beads 46 to a temperature of 100±5° C., the heating is carried out by means of application of hot air.

The background member 42 has various pictures, and as the light reflection member 40 is transparent, the pictures on the background member 42 can be seen well.

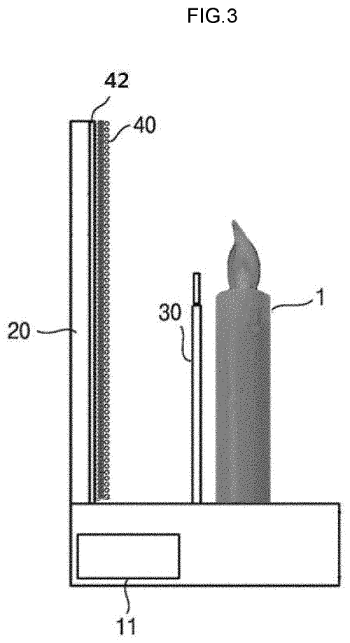

FIG. 3 is a side view showing an operation of a hologram production device according to the present invention. The substrate 20, the background member 42, the light reflection member 40, a lighting member 30, and an ornament 1 are arranged sequentially in order mentioned, and as shown in FIG. 3, circular holograms, which appear between the light reflection member 40 and the lighting member 30, are not seen at all when viewed on the side.

A controller 11 supplies power to the lighting member 30 and controls the illuminance of the lighting member 30.

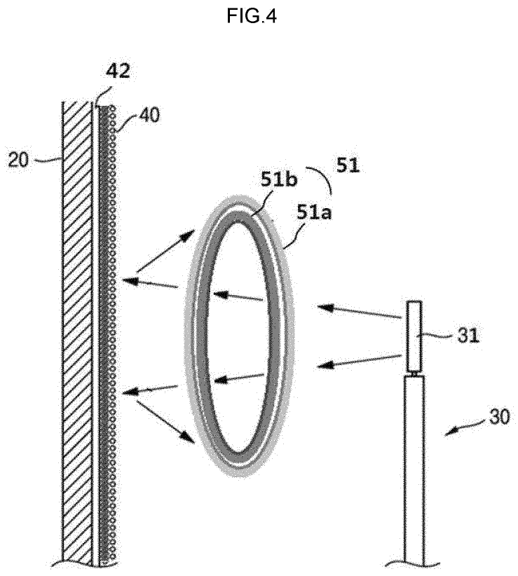

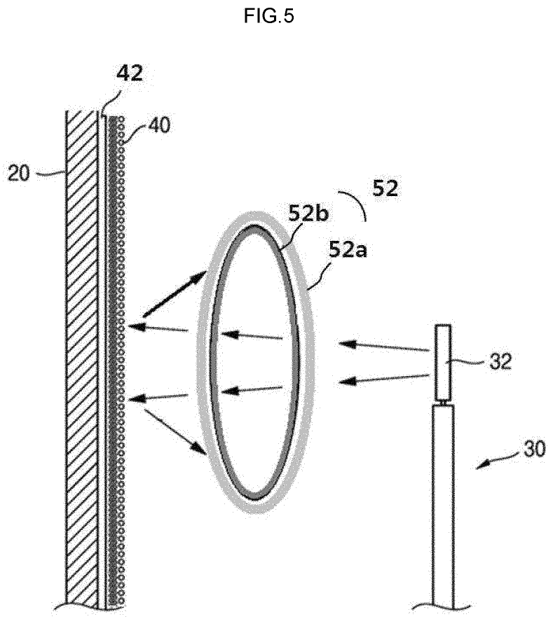

FIG. 4 is a perspective view showing a first operation of the hologram production device according to the present invention, and FIG. 5 is a perspective view showing a second operation of the hologram production device according to the present invention.

Two circular holograms per one lighting member 30 are produced. Even if the illuminance of the lighting member 30 is changed, densities of the two circular holograms are different from each other, but in this case, of course, the two circular holograms appear. First circular holograms 51a and 52a formed by means of the silibeads 44 are provided at the outside, and second circular holograms 51b and 52b formed by means of the polystyrene beads 46 are provided at the inside. Further, the densities of the first circular holograms 51a and 52a formed at the outside are lower than those of the second circular holograms 51b and 52b formed at the inside.

In detail, the circular hologram formed by means of the polystyrene beads 46 has a smaller diameter than that formed by means of the silibeads 44, but it has a higher density than that formed by means of the silibeads 44.

However, the present invention is not limited in allowing the two circular holograms to simply appear. Of course, the simple appearance of the two circular holograms has been suggested in the conventional practices.

As mentioned above, an object of the present invention is to provide a method for manufacturing a hologram production device, and further, another object of the present invention is to provide a dynamic effect of the two circular holograms through the hologram production device manufactured by the method.

A method for providing the dynamic effect of the two circular holograms is as follows. The lighting member 30 is constituted of one lighting member such as LED (Light Emitting Diode), OLED (Organic Light Emitting Diode), LCD (Liquid Crystal Display), PDP (Plasma Display Panel), and so on.

As shown in FIGS. 4 and 5, the lighting member 30 has one lighting, but the lighting has different illuminance values. In detail, the lighting member 30 has first lighting 31 and second lighting 32, and the control of the first lighting 31 and the second lighting 32 is carried out by means of the controller 11.

First, an explanation on the device using the silibeads 44 and the polystyrene beads 46 having particle sizes ranging from 0.2 to 0.3 mm will be given below.

In a first embodiment of the present invention, the illuminance of the first lighting 31 is higher than that of the second lighting 32. As shown in FIG. 4, first, the power of the lighting member 30 is turned on to generate the first lighting 31, so that the two first circular holograms 51a and 51b appear.

Next, the power of the lighting member 30 is turned off for 1/16 seconds or more so as to allow the two first circular holograms 51a and 51b produced by the first lighting 31 to disappear.

After that, as shown in FIG. 5, the power of the lighting member 30 is turned on to generate the second lighting 32, so that the two second circular holograms 52a and 52b appear.

Through the repetition of the above-mentioned operations, the two circular holograms are produced dynamically. If the power of the lighting member 30 is turned off for 1/16 seconds or more, the dynamic effect is produced, but if the power is turned off for 3 seconds or more, the dynamic effect may be deteriorated.

In a second embodiment of the present invention, the illuminance of the first lighting 31 of the lighting member 30 has power consumption of 10 watts (W), and the illuminance of the second lighting 32 of the lighting member 30 has power consumption of 3 watts (W). Their illuminance is slowly raised until it reaches their power consumption. In the first embodiment of the present invention, the power of the lighting member 30 is turned on/off at intervals of 1/16 seconds or more, but in the second embodiment of the present invention, the power of the first lighting 31 and the second lighting 32 is raised slowly until their power consumption reaches 10 watts and 3 watts. So as to provide a dynamic effect sufficiently, desirably, the power of the first lighting 31 and the second lighting 32 is raised within 3 seconds. In more detail, the second embodiment of the present invention will be explained below.

The power of the lighting member 30 as shown in FIG. 4 is turned on in such a manner as to be applied slowly from a low intensity current to a high intensity current for 3 seconds until the first lighting 31 reaches 10 watts. As a result, the two first circular holograms 51a and 51b appear, while their density becoming high for the 3 seconds.

So as to allow the two first circular holograms 51a and 51b produced by the first lighting 31 to slowly disappear, next, the power of the lighting member 30 is controlled so that it is completely turned off in 3 seconds.

After the power of the first lighting 31 is kept turned off for 1/16 seconds or more, the power of the lighting member 30 as shown in FIG. 5 is turned on in such a manner as to be applied slowly from a low intensity current to a high intensity current for 3 seconds until the second lighting 32 reaches 3 watts. As a result, the two second circular holograms 52a and 52b appear, while their density becoming high for the 3 seconds.

So as to allow the two second circular holograms 52a and 52b produced by the second lighting 32 to slowly disappear, next, the power of the lighting member 30 is controlled so that it is completely turned off in 3 seconds.

After the power of the second lighting 32 is kept turned off for 1/16 seconds or more, the power of the first lighting 31 is turned on through the method as mentioned above.

Through the repetition of the above-mentioned operations, the two circular holograms are produced dynamically. If the power of the lighting member 30 is turned off for 1/16 seconds or more, the dynamic effects are produced, but if the power is turned off for 3 seconds or more, the dynamic effects may be deteriorated.

In a third embodiment of the present invention, an explanation on a device mixing two kinds of silibeads 44 and polystyrene beads 46 having different particle sizes will be given. According to the third embodiment of the present invention, the particle sizes and the illuminance of the lighting member 30 are controlled to produce various hologram shapes like rainbow light.

The silibeads 44 and polystyrene beads 46 having particle sizes ranging from 0.2 to 0.3 mm are mixed with the silibeads 44 and polystyrene beads 46 having particle sizes smaller than 0.2 mm or larger than 0.3 mm, so that the illuminance of the lighting member 30 of the hologram production device is controlled to produce the rainbow light.

The present invention may be modified in various ways and may have several exemplary embodiments. Specific exemplary embodiments of the present invention are illustrated in the drawings and described in detail in the detailed description. However, this does not limit the invention within specific embodiments and it should be understood that the invention covers all the modifications, equivalents, and replacements within the idea and technical scope of the invention.

### INDUSTRIAL APPLICABILITY

According to the present invention, the method for manufacturing the light reflection member for producing a hologram effect of an ornament can be usefully applied to an industrial field where a device for producing a hologram effect of an ornament is produced and sold.

1. A method for manufacturing a light reflection member for producing a hologram effect of an ornament, the method comprising the steps of:
(a) applying an adhesive (41) to a substrate (20);
(b) attaching a background member (42) to the adhesive (41);
(c) applying an adhesive (43) to the background member (42);
(d) applying silibeads (44) to the adhesive (43);
(e) heating the silibeads (44) to a temperature of 160±5° C.;
(f) applying an adhesive (45) to the silibeads (44);
(g) applying polystyrene beads (46) to the adhesive (45); and
(h) heating the polystyrene beads (46) to a temperature of 100±5° C.,
wherein the adhesive (43) is transparent ink and the silibeads (44) comprise SiO₂, Na₂O, K₂O, CaO, MgO, Al₂O₃, B₂O₃, Fe₂O₃, ZnO, and PbO.

2. A hologram production device comprising a lighting member located between the light reflection member manufactured by the method according to claim 1 and the ornament, wherein power is applied to the lighting member to produce circular holograms.

3. The hologram production device according to claim 2, wherein the power of the lighting member is applied alternately at different voltages so that the lighting member has a first illuminance value and a second illuminance value.

4. The hologram production device according to claim 3, wherein the voltages are applied at a speed greater than 1/16 seconds or less than 3 seconds until the power of the lighting member reaches the first illuminance value and the second illuminance value.

5. The hologram production device according to claim 3, wherein the voltages at the first illuminance value and the second illuminance value are lowered at a speed greater than 1/16 seconds or less than 3 seconds so that the power of the lighting member is turned off.
